(19) United States
(12) Patent Application Publication
(10) Pub. No.: US 2012/0113188 A1
(43) Pub. Date: May 10, 2012

(54) IMAGE RECORDING APPARATUS AND CONTROLLING METHOD OF THE IMAGE RECORDING APPARATUS

(75) Inventor: Naoki ISHII, Tokyo (JP)

(73) Assignees: ORTEC CORPORATION, Tokyo (JP); RISO KAGAKU CORPORATION, Tokyo (JP)

(21) Appl. No.: 13/286,396

(22) Filed: Nov. 1, 2011

(30) Foreign Application Priority Data
Nov. 9, 2010 (JP) 2010-251237

(51) Int. Cl. B41J 2/165

(52) U.S. Cl. 347/34

(57) ABSTRACT

An image recording apparatus according to an embodiment of the present invention for recording an image on a recording medium by jetting ink obtains information of a jetting amount of the ink, obtains information of a flying distance of the ink in the jetting the ink, estimates an occurrence amount of ink mist, which is caused inside the image recording apparatus by the jetting the ink, based on the information of the jetting amount and the information of the flying distance, and determines whether or not to clean the inside of the image recording apparatus based on the estimated occurrence amount of ink mist.

### CROSS-REFERENCE TO RELATED APPLICATION

This application is based upon and claims the benefit of priority of the prior Japanese Patent Application No. 2010-251237, filed on Nov. 9, 2010, the entire contents of which are incorporated herein by reference.

### TECHNICAL FIELD

The present invention relates to an inkjet image recording apparatus and a controlling method of the image recording apparatus, and more particularly, to an image recording apparatus for estimating a contamination of the inside of the apparatus, which is caused by ink mist, and a controlling method of the image recording apparatus.

### BACKGROUND ART

For example, an inkjet full-line color image recording apparatus is known as an image recording apparatus. Such a full-line color image recording apparatus records a color image by being provided with a long recording head or a plurality of short recording heads, by way of example, for each of ink colors such as K (black), C (cyan), M (magenta) and Y (yellow). If the plurality of short recording heads are provided for each of the colors, they are arranged in a direction (main scanning direction) orthogonal to a conveyance direction (sub-scanning direction) of a recording medium.

At a position facing such a long recording head or a plurality of short recording heads, a conveyance mechanism for conveying a recording medium is provided. An image recording unit, for example, receives recording instruction information (a print job or the like) that is transmitted from a higher-level device and includes recording data, and records an image on a recording medium that is conveyed just below the image recording unit by jetting ink of each of the colors KCMY from the recording head based on the recording instruction information.

In such an image recording apparatus, it is known that ink droplets jetted from the recording head are broken down and generate ink mist, which contaminates the inside of the recording apparatus. Accordingly, it is needed to detect a predetermined amount of contamination and to make a notification of urging the cleaning of the inside of the apparatus.

For example, Japanese Laid-open Patent Publication No. 2009-12282 (hereinafter referred to as Patent Document 1) is proposed as a technique for detecting a contamination inside an apparatus. Patent Document 1 discloses a technique for preventing a recording medium from being contaminated by counting the jetting amount of ink and by making display means display a message that urges the cleaning of a platen if the jetting amount of ink exceeds a predetermined amount.

### SUMMARY OF THE INVENTION

According to an embodiment of the present invention, an image recording apparatus for recording an image on a recording medium by jetting ink includes: a jetting amount information obtaining unit configured to obtain information of a jetting amount of the ink; a flying distance information obtaining unit configured to obtain information of a flying distance of the ink when being jetted; an ink mist occurrence amount estimating unit configured to estimate an occurrence amount of ink mist, which is caused inside the image recording apparatus by jetting the ink, based on the information of the jetting amount and the information of the flying distance; and a determining unit configured to determine whether or not to clean an inside of the image recording apparatus based on the occurrence amount of ink mist, which is estimated by the ink mist occurrence amount estimating unit.

According to an embodiment of the present invention, a method for controlling an image recording apparatus for recording a recording medium by jetting ink includes: obtaining information of a jetting amount of the ink; obtaining information of a flying distance of the ink in the jetting the ink; estimating an occurrence amount of ink mist, which is caused inside the image recording apparatus by the jetting the ink, based on the information of the jetting amount and the information of the flying distance; and determining whether or not to clean an inside of the image recording apparatus based on the occurrence amount of ink mist, which is estimated by the estimating.

### BRIEF DESCRIPTION OF THE DRAWINGS

The present invention will be more apparent from the following detailed description when the accompanying drawings are referenced.

FIG. 1 is a block diagram illustrating an image recording apparatus according to an embodiment of the present invention;

FIG. 2 illustrates an arrangement of components included in the image recording apparatus according to an embodiment of the present invention;

FIG. 3 is a flowchart for explaining a process for determining whether or not to clean the inside of the image recording apparatus, which is executed by a controlling unit in an embodiment of the present invention;

FIG. 4 illustrates an example of a table that is used to estimate an occurrence amount of ink mist in a first embodiment of the present invention and includes type information, a gap distance and correction information; and

FIG. 5 illustrates an example of a table that is used to estimate the occurrence amount of ink mist in a second embodiment of the present invention and includes type information, a gap distance and correction information set for each ink type.

### DESCRIPTION OF THE EMBODIMENTS

Embodiments according to the present invention are described in detail below with reference to the drawings. The following description refers to examples of using an inkjet full-line image recording apparatus as an image recording apparatus.

In the full-line image recording apparatus, recording heads (nozzle lines) are provided respectively for ink colors at predetermined intervals in a direction (sub-scanning direction) for conveying a recording medium. In the recording heads, a plurality of nozzles for jetting ink are arranged in length equal to or longer than the width of the recording medium in a direction (main scanning direction) orthogonal to the sub-scanning direction. Moreover, the full-line image recording apparatus can execute a process for recording a desired character or image at high speed by jetting ink from the plurality of nozzles of a recording head of each color onto the recording medium.

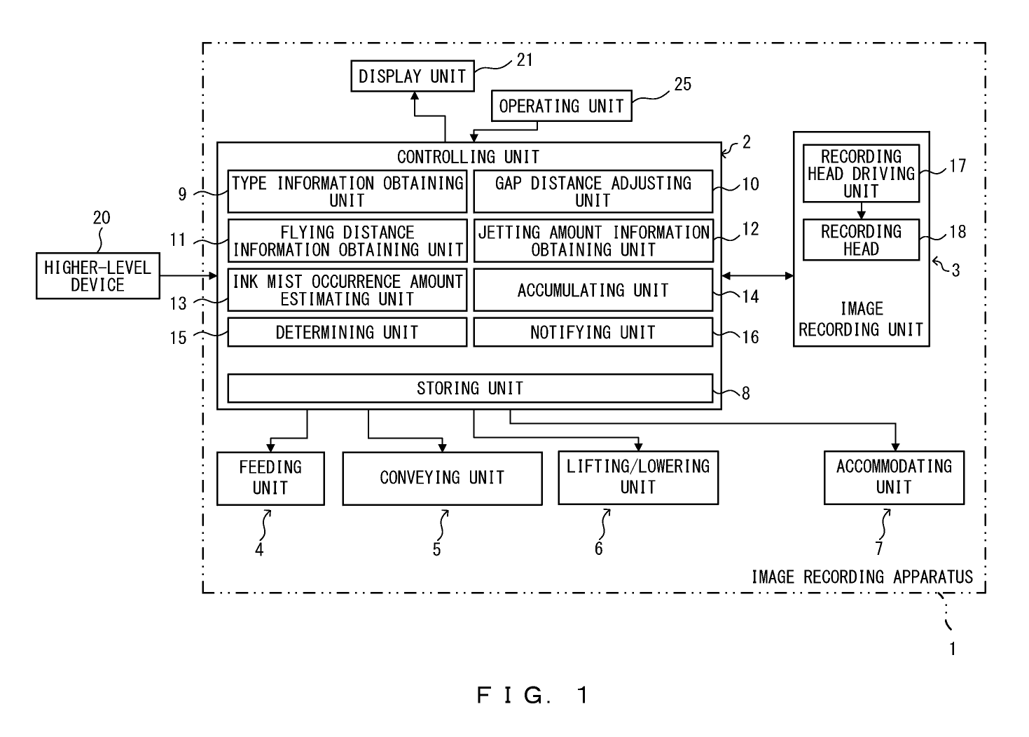

FIG. 1 is a block diagram illustrating a configuration of an image recording apparatus 1 according to an embodiment. As illustrated in FIG. 1, the image recording apparatus 1 includes a controlling unit 2, an image recording unit 3, a feeding unit 4, a conveying unit 5, a lifting/lowering unit 6, an accommodating unit 7, a display unit 21 and an operating unit 25.

The controlling unit 2 includes, for example, an MPU (Micro Processor Unit) or the like, and has a control function and a computation function. The controlling unit 2 includes a storing unit 8.

The storing unit 8 includes, for example, a ROM (Read Only Memory) for storing a control program, a RAM (Random Access Memory) that the MPU uses as a working storage area, a nonvolatile memory for storing various types of setting values and the like for a control of the image recording apparatus 1, and the like. In an embodiment according to the present invention, the storing unit 8 stores information of a threshold value for determining whether or not to clean the inside of the apparatus, and a table that makes an association among type information about a type of a recording medium, information about a flying distance of jetted ink, and correction information for correcting an occurrence amount of ink mist.

The controlling unit 2 can function as, for example, a type information obtaining unit 9, a gap distance adjusting unit 10, a flying distance information obtaining unit 11, a jetting amount information obtaining unit 12, an ink mist occurrence amount estimating unit 13, an accumulating unit 14, a determining unit 15 and a notifying unit 16 by executing a control program stored, for example, in the ROM.

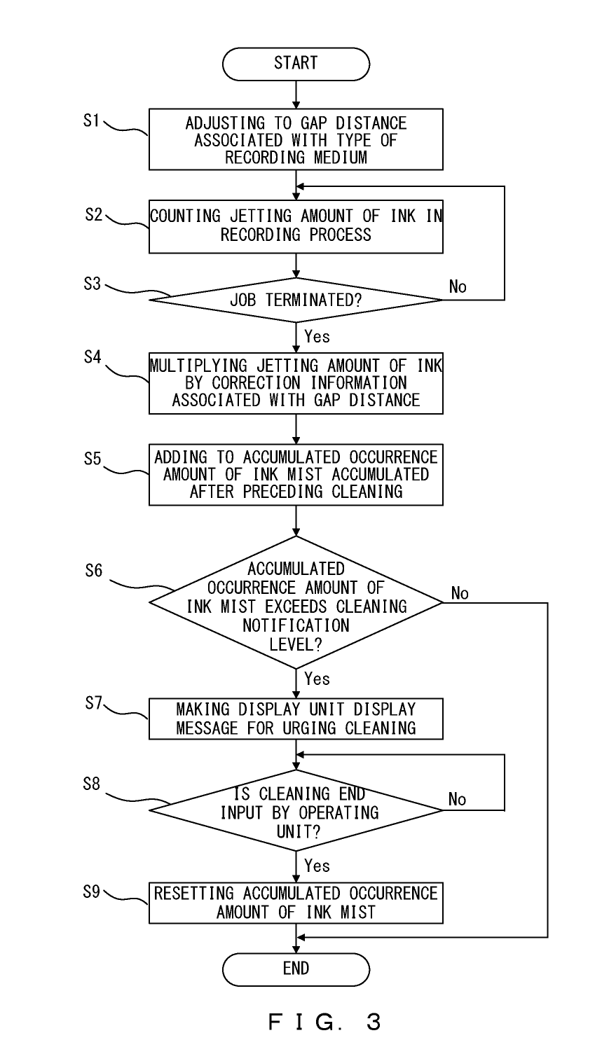

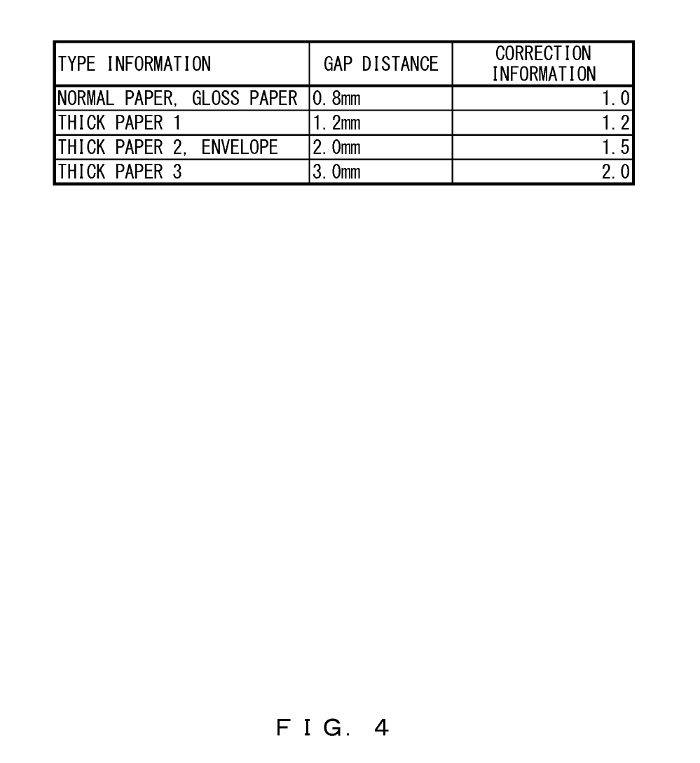

The type information obtaining unit 9 obtains information (type information) about the type of a recording medium based on, for example, recording instruction information received from a higher-level device 20, information about the feeding unit 4 for feeding the recording medium, or the like. The gap distance adjusting unit 10 adjusts a distance between the image recording unit 3 and the conveying unit 5 by controlling the driving of the lifting/lowering unit 6 based on the obtained type information of the recording medium. The jetting amount information obtaining unit 12 obtains information of the jetting amount of ink jetted from a recording head 18. The flying distance information obtaining unit 11 obtains information of the flying distance of ink jetted from the recording head 18 onto a recording medium 22. The flying distance information obtaining unit 11 obtains, for example, information of a gap distance between the image recording unit 3 and the conveying unit 5 as the information of the flying distance. The ink mist occurrence amount estimating unit 13 obtains the occurrence amount of ink mist by correcting the information of the jetting amount obtained by the jetting amount information obtaining unit 12 with correction information to be described later. The accumulating unit 14 obtains an accumulated occurrence amount of ink mist by executing a process for accumulating the occurrence amount of ink mist, which is estimated by the ink mist occurrence amount estimating unit 13. The determining unit 15 determines whether or not to clean the inside of the apparatus by comparing the accumulated occurrence amount of ink mist with a predetermined threshold value stored in the storing unit 8. The notifying unit 16 outputs an output signal if the determining unit 15 determines to clean the inside of the apparatus . These functions will be described in detail later with reference to FIGS. 3 and 4.

The functioning units (such as the gap distance adjusting unit 10, the determining unit 15 and the like) implemented in a way such that the above described controlling unit 2 executes the program may be configured not as software but as hardware such as signal processing circuits controlled by the MPU of the controlling unit 2.

The image recording unit 3 includes a recording head (nozzle line) 18 composed of a plurality of nozzles, and a recording head driving unit 17 for individually driving the nozzles to jet ink. The nozzles record an image by jetting ink onto the recording medium 22 conveyed by the conveying unit 5.

The feeding unit 4 loads the recording medium 22, and feeds the recording medium 22 to the conveying unit 5. The conveying unit 5 conveys the recording medium 22 fed by the feeding unit 4 to a position to which the ink jetted by the image recording unit 3 reaches, and conveys the recording medium 22 to the accommodating unit 7 thereafter. The accommodating unit 7 accommodates the recording medium 22 conveyed by the conveying unit 5.

The operating unit 25 is connected to the controlling unit 2. The operating unit 25 accepts, for example, an input operation, such as an execution instruction of an image recording process, input by a user, and notifies the controlling unit 2 of the accepted input operation. Moreover, in an embodiment, the operating unit 25 also accepts an input operation, such as a termination of the cleaning, input by the user.

The display unit 21 is connected to the controlling unit 2, and displays, for example, information of a state of the image recording apparatus according to a control of the controlling unit 2. Moreover, in an embodiment, the display unit 21 displays a message for urging the cleaning of the inside of the apparatus, and notifies a user that the inside of the apparatus is contaminated.

The lifting/lowering unit 6 adjusts the distance between the image recording unit 3 and the conveying unit 5 by lifting/lowering the conveying unit 5 according to a control performed by the gap distance adjusting unit 10 (controlling unit 2).

In FIG. 1, the image recording apparatus 1 is connected to a higher-level device 20 such as a personal computer (PC) or the like. In an embodiment, the image recording apparatus 1 receives the recording instruction information from the higher-level device 20, and executes a recording process onto a recording medium according to the received recording instruction information.

However, the image recording apparatus does not always need to be connected to the higher-level device. In another embodiment, for example, a storage medium such as a flash memory or the like may be connected to the image recording apparatus, and the recording instruction information may be generated based on data stored on the storage medium and a recording process may be executed.

The recording instruction information may be data, such as a print job or the like, which instructs the image recording apparatus 1 to execute a recording process onto a recording medium. If the recording instruction information is data for instructing recording processes to be executed onto a plurality of recording media, the recording processes are executed onto the plurality of recording media using one piece of recording instruction information.

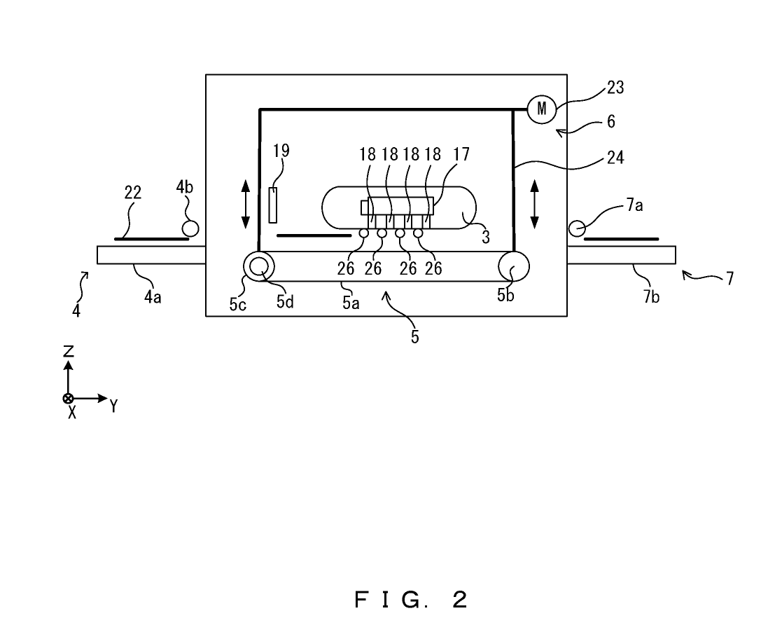

FIG. 2 illustrates an arrangement of the components included in the image recording apparatus 1 according to an embodiment. In FIG. 2, components that correspond to those of FIG. 1 are denoted with the same reference numerals as those of FIG. 1.

In FIG. 2, the image recording apparatus 1 includes the image recording unit 3, the feeding unit 4, the conveying unit 5, the lifting/lowering unit 6, the accommodating unit 7 and the recording medium detecting unit 19. In FIG. 2, for example, the controlling unit 2, the display unit 21, the operating unit 25 and the like are omitted.

The image recording unit 3 includes at least one recording head 18 having a plurality of nozzles for jetting ink in a recording process, and the recording head driving unit 17 configured to individually drive the nozzles according to a driving instruction issued from the controlling unit 2. Moreover, the image recording unit 3 is provided with pressing rollers 26 for pressing the floating of a recording medium 22 from a conveyance member 5a.

The feeding unit 4 includes a feeding tray 4a for loading the recording medium 22, and a feeding roller 4b for feeding the recording medium 22 out of the feeding tray 4a. The feeding unit 4 drives the feeding roller 4b according to an instruction issued from the controlling unit 2 to feed the recording medium 22 to the conveying unit 5.

The recording medium detecting unit 19, provided on a further upstream side of the image recording unit 3 in the conveying unit 5, detects the front edge and/or the rear edge in the sub-scanning direction of the recording medium 22 that the feeding unit 4 feeds to the conveying unit 5. The recording medium detecting unit 19 may be configured, for example, such that an optical reflection sensor is included in a portion of it. The recording medium detecting unit 19 notifies the controlling unit 2 of a detection signal upon detection of the front edge and/or the rear edge of the recording medium 22.

The conveying unit 5 includes a conveyance member 5a, a conveyance driving unit 5b, a conveyance following unit 5c and a conveyance information generating unit 5d. The conveyance member 5a is configured, for example, with a conveyer belt or the like, and loads and conveys the recording medium 22 fed by the feeding unit 4. The conveyance driving unit 5b and the conveyance following unit 5c may be, for example, rollers. The conveyance driving unit 5b rotates and drives the conveyance member 5a along with the conveyance following unit 5c according to a driving instruction issued from the controlling unit 2, and the recording medium 22 is loaded and conveyed by the conveyance member 5a. The conveying units conveys the recording medium 22 fed by the feeding unit 4 to a position to which ink jetted by the image recording unit 3 reaches, and conveys the recording medium 22 to the accommodating unit 7 thereafter.

Additionally, the conveyance following unit 5c provides the conveyance information generating unit 5d. The conveyance information generating unit 5d is, for example, a rotary encoder, and outputs a pulse signal that is synchronous with a rotation of the conveyance following unit 5c. Accordingly, this pulse signal is information (hereinafter referred to as conveyance information) that indicates a conveyance distance of the recording medium 22 conveyed by the conveyance member 5a.

The controlling unit 2 determines the timing of jetting ink from the nozzles of the image recording unit 3 based on the detection signal output from the recording medium detecting unit 19 and the conveyance information output from the conveyance information generating unit 5d. The controlling unit 2 obtains the conveyance information of the recording medium 22, which is output from the conveyance information generating unit 5d, from a time point when the recording medium 22 is detected by the recording medium detecting unit 19, and causes the recording head 18 to jet ink by controlling the recording head driving unit 17 at the timing when the recording medium 22 is conveyed to a position facing the recording head 18, and thereby the recording process is executed.

The accommodating unit 7 includes a paper ejection roller 7a and an accommodation tray 7b. The recording medium 22 on which the image recording unit 3 has executed the recording process is conveyed by the conveying unit 5 to the accommodating unit 7, is ejected outside the apparatus by the paper ejection roller 7a, and is accommodated in the accommodation tray 7b.

The lifting/lowering unit 6 includes a motor 23, a wire 24 for lifting/lowering the conveying unit 5, and a gap adjustment mechanism not illustrated. A brushless motor is used as the motor 23 in this embodiment. However, various types of motors such as a pulse motor and the like may be used as the motor 23. The conveying unit 5 is provided with the wire 24. By driving the motor 23 to adjust the length of the wire 24, the conveying unit 5 is lifted/lowered in a direction indicated with an arrow. The lifting/lowering unit 6 lifts/lowers the conveying unit 5 according to a control of the gap distance adjusting unit 10 (controlling unit 2), whereby the gap distance between the image recording unit 3 and the conveying unit 5 is adjusted.

The adjustment of the gap distance by the gap distance adjusting unit 10 and the lifting/lowering unit 6 is made according to the type information of the recording medium 22, which is obtained by the type information obtaining unit 9 in an embodiment. The image recording apparatus 1 can execute a recording process onto various types of recording media 22, which are different in thickness, shape, material and the like depending on their types.

If a recording process is executed onto such various types of recording media with the same gap distance, the recording media 22 may jam while being conveyed by the conveying unit 5 because, for example, the distance between the nozzles and the conveyance member 5a or the distance between the pressing rollers 26 and the conveyance member 5a is too short. For this reason, in some embodiments according to the present invention, the image recording apparatus 1 includes the lifting/lowering unit 6. The gap distance adjusting unit 10 drives the lifting/lowering unit 6 depending on the type of a recording medium, and thereby the conveying unit 5 is lifted/lowered. Therefore, recording media being conveyed can be prevented from jamming or the like even when the various types of recording media 22 are conveyed.

The recording media 22 are media on which an image is recorded by the image recording apparatus 1. Examples of the recording media 22 include paper, a cloth, a seal, a film and the like. The recording media 22 include various types of recording media that are different, for example, in size (such as a postcard size, A4 size, A5 size, B4 size and the like), in material (such as normal paper, gloss paper for photos, and the like), in thickness (such as normal paper, thick paper, an envelope and the like), in shape (such as normal paper, an envelope and the like), and in other points.

In an embodiment, the type of a recording medium 22 is identified by the type information obtaining unit 9 based on the type information. The type information is information about the type of a recording medium 22. The type information of a recording medium to be recorded is obtained, for example, with the following method.

In an embodiment, assume that the image recording apparatus 1 includes a plurality of feeding units 4 and that each of the plurality of feeding units 4 respectively loads a different type of recording media 22. Moreover, a table that makes an association between each of the feeding units 4 and the type information of the recording medium 22 loaded by a corresponding feeding unit 4 is stored in the storing unit 8 of the image recording apparatus 1. With such a configuration, the type information obtaining unit 9 identifies the feeding unit 4 that has fed the recording medium 22 at the time of a recording process, and thereby the type information of the recording medium 22 associated with the corresponding feeding unit 4 can be obtained by referencing the table stored in the storing unit 8. The gap distance adjusting unit 10 obtains a gap distance based on the type information obtained by the type information obtaining unit 9, and adjusts the gap distance to the obtained distance.

Alternatively, in another embodiment, the type information obtaining unit 9 may obtain the type information of the recording medium, which is included in recording instruction information, from the recording instruction information received from the higher-level device 20. For example, a user specifies the type of a recording medium to be used for recording via a driver of the image recording apparatus 1, which is installed in the higher-level device, when the higher-level device 20 instructs the image recording apparatus 1 to perform the recording process. The driver of the image recording apparatus 1 converts the specified type of the recording medium into type information, which is then included in the recording instruction information and is transmitted to the image recording apparatus 1. As a result, the type information obtaining unit 9 can obtain the type information of the recording medium 22 from the received recording instruction information. The gap distance adjusting unit 10 obtains a gap distance based on the type information obtained by the type information obtaining unit 9, and adjusts the gap distance to the obtained distance.

In the above described embodiment, a relationship between the type of a recording medium and the gap distance to be adjusted is determined according to the thickness of the recording medium in most cases. Namely, there is a tendency for the thickness of the recording medium 22 to be thicker and the setting of the gap distance to be longer. However, the relationship between the type of the recording medium and the gap distance does not depend only on a difference of the thickness of a recording medium. The relationship is also influenced by the material or the shape of the recording medium.

For example, if the recording medium is an envelope, it is inflated by the air or the like that gets into the inside of a double structure of the envelope, and may possibly become thicker than the original thickness of the envelope. In such a case, the gap distance is set to a longer distance in order to take the factor of the inflation into account. The gap distance is set by taking the type of the recording medium into account in order not to cause a trouble such as jamming or the like of the recording medium on a conveyance path.

A first embodiment according to the present invention is described below. In the first embodiment, the occurrence amount of ink mist is estimated by taking into account a difference of the gap distance at the time of ink jetting.

The possibility that ink droplets jetted from the recording head break down and generate ink mist rises with an increase in the flying distance of ink. Therefore, also the occurrence rate of ink mist rises with an increase in the gap distance. Accordingly, the flying distance of ink droplets varies if the image recording apparatus 1 includes the lifting/lowering unit 6 to adjust the gap distance. Therefore, an error occurs in the estimation of the occurrence amount of ink mist if the estimation is made based only on the jetting amount of ink.

The first embodiment addresses this problem. Namely, a change of the occurrence rate of ink mist, which is caused by a change of the gap distance, is reflected on the estimation of the occurrence amount of ink mist by making a correction. Therefore, an estimation error is suppressed.

A process for determining whether or not to clean the inside of the image recording apparatus 1 according to the first embodiment is described with reference to FIG. 3. The process illustrated in FIG. 3 is executed by the controlling unit 2. Such a process may be executed in a way such that a program is created and stored in the storing unit 8 to make the controlling unit 2 execute the process and the controlling unit 2 reads and executes the program.

The flow illustrated in FIG. 3 starts at the timing when the image recording apparatus 1 receives recording instruction information. In step S1, the controlling unit 2 obtains type information included in recording instruction information upon receipt of the recording instruction information. Then, the controlling unit 2 references the table of FIG. 4 stored in the storing unit 8 by using the obtained type information. The table of FIG. 4 is a table that makes an association among type information indicating the type of a recording medium, the gap distance between the image recording unit 3 and the conveying unit 5, and correction information (this table will be described in detail later). By referencing this table, the controlling unit 2 obtains information of the gap distance associated with the type information obtained from the recording instruction information. The controlling unit 2 adjusts a gap distance to a distance indicated by the obtained information of the gap distance by controlling the lifting/lowering unit 6.

In step S2, the controlling unit 2 controls the recording head driving unit 17 according to the recording instruction information, and thereby the recording process is executed onto the recording medium, and counts the jetting amount of ink jetted in the recording process.

Upon termination of the recording process, whether or not the recording instruction information includes data instructing a recording process onto the next recording medium is determined in step S3.

If the recording instruction information does not include the data instructing the recording process onto the next recording medium and all recording processes indicated by the recording instruction information are terminated, step S3 is determined to be “YES”. Then, the flow goes to step S4.

Alternatively, if the recording instruction information includes the data instructing the recording process onto the next recording medium and all the recording processes instructed by the recording instruction information are not terminated yet, step S3 is determined to be “NO”. Then, the flow goes back to step S2 and the recording process onto the next recording medium is executed and the jetting amount of ink used in this recording process is counted.

In this way, the recording process and the counting of the jetting amount of ink used in the recording process are performed until all the recording processes instructed by the recording instruction information are terminated in the processes of steps S2 and S3. Note that information of the jetting amount of ink, which is counted in step S2, is accumulated each time a recording process is executed. Accordingly, the information of the jetting amount of ink, which is used in step S4, is information of the jetting amount of ink used to execute all recording processes instructed by one piece of recording instruction information.

The above described information of the jetting amount of ink is the number of ink droplets jetted from the nozzles in the first embodiment. The controlling unit 2 counts the number of ink droplets jetted from the nozzles, for example, as follows.

Assume that a recordable resolution of the recording head 18 is 400 dpi (dots/inch) (both in the main scanning direction and in the sub-scanning direction). This resolution is approximately 15.7 dots/mm if it is denoted in dots/mm. Assuming that a recording medium is A4-sized paper, the size of the paper is 210×297 mm. If the A4-sized recording medium is recorded with the recording head of 400 dpi, there are

210×15.7=3297≈300 dots in each line in the main scanning direction, and

297×15.7=4662.9≈4700 dots in each line in the sub-scanning direction.

Accordingly, when one face of the A4-sized paper is recorded with this recording head, ink of 15,500,000 dots is jetted at the maximum.

Upon receipt of the recording instruction information from the higher-level device 20, the controlling unit 2 generates bitmap data based on the recording instruction information according to the recordable resolution (400 dpi here) of the recording head 18 included in the image recording apparatus 1. Then, based on the generated bitmap data, the controlling unit 2 controls which dots are to be jetted with ink among approximately the 16,000,000 dots on the A4-sized recording medium via the recording head driving unit 17. Accordingly, the controlling unit 2 can count the number of ink droplets jetted onto the recording medium in the recording process using the bitmap data generated at the time of ink jetting. In this way, the controlling unit 2 obtains the number of ink droplets used to execute all the recording processes instructed by the recording instruction information (steps S2 and S3). Then, the flow goes to step S4.

In step S4, the controlling unit 2 obtains the information of the gap distance adjusted in step S1. The controlling unit 2 may obtain the information of the gap distance from the type information in a similar manner as in step S1, for example, by referencing the table that is illustrated in FIG. 4 (FIG. 4 will be described in detail later) and stored in the storing unit 8. Alternatively, in another embodiment, the controlling unit 2 may obtain the information of the gap distance from the storing unit 8 after storing the information of the gap distance obtained in step S1 in the storing unit 8.

The controlling unit 2 obtains correction information associated with the information of the gap distance by referencing the table of FIG. 4 (FIG. 4 will be described later) with the use of the obtained information of the gap distance. The controlling unit 2 corrects the occurrence amount of ink mist by multiplying the information of the jetting amount of ink (the number of jetted ink droplets), which is obtained in steps S2 and S3, by the obtained correction information, and holds the corrected value as the occurrence amount of ink mist (step S4).

In step S5, the controlling unit 2 reads the accumulated occurrence amount of ink mist, which is recorded in the storing unit 8, that is accumulated after the preceding cleaning. Then, the controlling unit 2 updates the accumulated occurrence amount of ink mist by adding the occurrence amount of ink mist, which is estimated in step S4, to the read accumulated occurrence amount of ink mist, and stores the updated amount in the storing unit 8.

In step S6, the controlling unit 2 reads a predetermined threshold value stored in the storing unit 8. Then, the controlling unit 2 makes a comparison between the read predetermined threshold value and the accumulated occurrence amount of ink mist, which is updated in step S5, and determines whether or not the accumulated occurrence amount of ink mist exceeds the threshold value.

The threshold value is set to a value indicating that the inside of the apparatus is so contaminated as to be cleaned if the accumulated occurrence amount of ink mist exceeds the threshold value, or a value indicating that the inside of the apparatus is not so contaminated as to be cleaned if the accumulated occurrence amount of ink mist does not exceed the threshold value.

Preferably, the threshold value is set to a value as large as possible in order to lighten a user's burden of cleaning the inside of the apparatus. However, to prevent a recording medium from being contaminated by a contamination of the inside of the apparatus at the time of recording, the threshold value may be set to a value obtained by subtracting a suitable margin from an empirically estimated maximum value of the number of jetted ink droplets by which the inside of the apparatus is so contaminated as to require cleaning.

If the accumulated occurrence amount of ink mist is equal to or smaller than the threshold value in step S6, it indicates that the inside of the apparatus is not so contaminated as to be cleaned. Therefore, step S6 is determined to be “NO”, and this job is terminated.

Alternatively, if the accumulated occurrence amount of ink mist exceeds the threshold value in step S6, it indicates that the inside of the apparatus is contaminated by the occurrence of ink mist at an unacceptable level. Therefore, step S6 is determined to be “YES”, and the flow goes to step S7.

In step S7, the controlling unit 2 outputs an output signal for a notification, and notifies the user that the inside of the apparatus is contaminated by making the display unit 21 display a message for urging the cleaning. Therefore, the user of the image recording apparatus 1 can learn that the inside of the image recording apparatus 1 is contaminated by the occurrence of ink mist at the unacceptable level with the viewing of the message displayed on the display unit 21, whereby he or she can take measures such as the cleaning of the inside of the apparatus.

The notification for urging the cleaning is not limited to that made via the display unit 21. The notification may be, for example, a sound notification, warning mail transmitted to the higher-level device, or the like. Alternatively, if the image recording apparatus 1 is provided with a function of automatically cleaning the inside of the apparatus, the inside of the apparatus may be automatically cleaned if step S6 is determined to be “YES”. In this case, the processes in steps S7 and S8 may be omitted.

In step S8, the controlling unit 2 waits until a signal indicating that the cleaning is terminated is input from the operating unit 25 (“NO” in step S8).

If the signal indicating that the cleaning is terminated is input from the operating unit 25 instep S8 (“YES” in step S8), the flow goes to step S9, in which the controlling unit 2 resets the accumulated occurrence amount of ink mist, which is stored in the storing unit 8, to an initial value (such as “0”). Then, this received job is terminated.

As described above, in the first embodiment, the image recording apparatus 1 corrects the occurrence amount of ink mist by using correction information in order to reflect a change of the occurrence rate of ink mist, which is caused by a change of the gap distance, on the estimation of the occurrence amount of ink mist. Accordingly, the occurrence amount of ink mist can be estimated with higher accuracy than that in the case of estimating the occurrence amount of ink mist only based on the number of jetted ink droplets. Therefore, the timing of cleaning the inside of the image recording apparatus 1 can be estimated with higher accuracy. As a result, a notification for urging the cleaning is prevented from being mistakenly made although the inside of the apparatus is not so contaminated as to be cleaned, or a notification is prevented from being not made although the inside of the apparatus is so contaminated as to be cleaned, and a recording medium is prevented from being contaminated by the contamination of the inside of the apparatus.

In the flow of FIG. 3, the controlling unit 2 functions as the type information obtaining unit 9 in the process for obtaining the type information in step S1. In the process for adjusting a gap distance to a gap distance associated with the type information in step S1, the controlling unit 2 functions as the gap distance adjusting unit 10. In the process for counting the information of the jetting amount of ink in steps S2 and S3 (the number of jetted ink droplets in the first embodiment), the controlling unit 2 functions as the jetting amount information obtaining unit 12. In the process for obtaining the information of the gap distance in step S4, the controlling unit 2 functions as the flying distance information obtaining unit 11. Moreover, in the process for obtaining correction information associated with the obtained gap information from the table of FIG. 4 and for multiplying the information of the jetting amount by the obtained correction information in step S4, the controlling unit 2 functions as the ink mist occurrence amount estimating unit 13. In the process for updating the accumulated occurrence amount of ink mist in step S5, the controlling unit 2 functions as the accumulating unit 14. In the process for determining whether or not to clean the inside of the apparatus in step S6, the controlling unit 2 functions as the determining unit 15. In the process for outputting the output signal for a notification instep S7, the controlling unit 2 functions as the notifying unit 16.

An embodiment of setting the threshold value, used in the determination of step S6, of the accumulated occurrence amount of ink mist is described here. In FIG. 4, correction information of 1.0 is associated with a gap distance of 0.8 mm. Therefore, the number of jetted ink droplets counted based on the gap distance 0.8 mm is directly added to the accumulated occurrence amount of ink mist. Accordingly, it is convenient to use the gap distance of 0.8 mm for the setting of the threshold value of the accumulated occurrence amount of ink mist, which is used to determine whether or not the inside of the apparatus is so contaminated as to be cleaned.

With the gap distance of 0.8 mm, by way of example, a solid image is continuously recorded, and the number of ink droplets jetted in the recording of the solid image and the degree of contamination inside the image recording apparatus 1 are monitored. As a result of this monitoring, the maximum value of the number of jetted ink droplets by which the recording medium is not contaminated by the contamination of the inside of the image recording apparatus 1 can be empirically estimated.

Thus estimated maximum value of the number of jetted ink droplets can be set as the threshold value of the accumulated occurrence amount of ink mist. Alternatively, in another embodiment, the threshold value of the accumulated occurrence amount of ink mist may be set by subtracting a suitable value of a margin from the estimated maximum value of the number of jetted ink droplets in order to more securely prevent the recording medium from being contaminated by the contamination of the inside of the apparatus.

FIG. 4 is described next. The table of FIG. 4 makes an association among the type information of a recording medium, information of a gap distance, and correction information for obtaining the occurrence amount of ink mist by correcting the number of jetted ink droplets. The type information is information about the type of a recording medium. For example, normal paper, thick paper 1, thick paper 2, an envelope are illustrated as the type information in FIG. 4. The information of the gap distance is information of a distance between the image recording unit 3 and the conveying unit 5, and this distance is adjusted in such a way that the gap distance adjusting unit 10 controls the lifting/lowering unit 6. For example, values such as 0.8 mm, 1.2 mm, 2.0 mm and 3.0 mm are illustrated as gap distances in FIG. 4. In the first embodiment, the correction information is information for correcting the number of jetted ink droplets so that a change of the occurrence rate of ink mist, which is caused with a change of the gap distance, is reflected on the estimation of the occurrence amount of ink mist.

In this embodiment, the correction information represents a relative ratio of the occurrence amounts of ink mist generated by jetting ink respectively with the gap distances (the correction information of 1.0, 1.2, 1.5 and 2.0 in FIG. 4). Namely, in FIG. 4, the correction information of 1.0 is associated with the gap distance of 0.8 mm, and the correction information of 1.5 is associated with the gap distance of 2.0 mm. This indicates that the occurrence rate of ink mist with the gap distance of 2.0 mm is 1.5/1.0, which is higher by 1.5 times than that with the gap distance of 0.8 mm.

In some embodiments according to the present invention, the correction information is information for correcting an estimated value of the occurrence amount of ink mist to a more accurate value. Such correction information can be determined, for example, as a relative ratio of the occurrence amount (occurrence rate), assumed to be 1, of ink mist under one recording condition used to determine the threshold value of the accumulated occurrence amount of ink mist to the occurrence amount (occurrence rate) of ink mist under another recording condition.

To determine the correction information, for example, the values of the correction information illustrated in FIG. 4 in the first embodiment are obtained by monitoring the number of jetted ink droplets and the degree of contamination of the inside of the apparatus respectively with the gap distances and by estimating threshold values respectively for the gap distances in a similar manner as in the case of obtaining a threshold value of the accumulated occurrence amount of ink mist. Since these threshold values are values respectively correlated with the occurrence amounts (occurrence rates) of ink mist, the correction information can be determined by using a relative ratio of the respectively estimated threshold values. For example, if the threshold value of the number of jetted ink droplets with the gap distance of 0.8 is 1,500,000,000 droplets, and the threshold value of the number of jetted ink droplets with the gap distance of 2.0 is 1,000,000,000 droplets, the correction information can be determined as 1,500,000,000/1,000,000,000=1.5. This indicates that the occurrence amount (occurrence rate) of ink mist with the gap distance of 2.0 mm is higher by 1.5 times than that with the gap distance of 0.8 mm.

The first embodiment refers to the example of estimating the threshold value of the accumulated occurrence amount of ink mist and the value of the correction information by monitoring the number of jetted ink droplets and the degree of contamination of the inside of the apparatus. However, the method for estimating these values is not limited to this one. These values can be determined with various methods.

For example, the threshold value may be empirically determined by a user, or may be changed according to a usage state of the image recording apparatus 1.

Additionally, the first embodiment refers to the example of obtaining the type information of a recording medium from recording instruction information received from the higher-level device. However, the type information is not limited to that obtained in this way. The type information of the recording medium can be obtained with various methods. For example, the controlling unit 2 may obtain the type information of the recording medium 22 associated with a corresponding feeding unit 4 based on information of the feeding unit 4 that has fed the recording medium 22 at the time of a recording process.

The second embodiment described below refers to an example of correcting an estimation error of the occurrence amount of ink mist, which is caused by another factor except for a change of the gap distance. Since the second embodiment includes processes similar to those of the first embodiment, this embodiment is described with reference to FIG. 3.

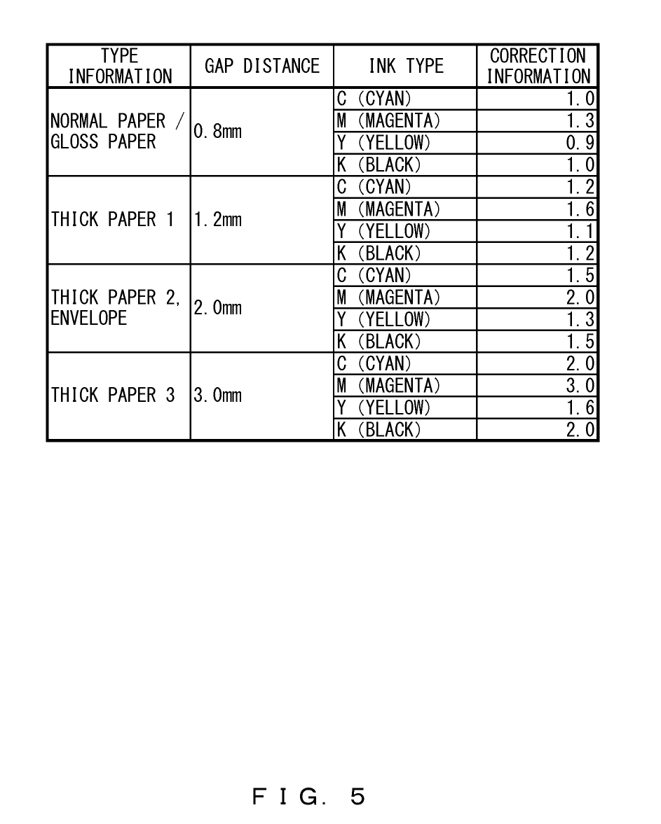

In the second embodiment, the process of FIG. 3 starts at the timing when the image recording apparatus 1 receives recording instruction information. In step S1, in a similar manner as in the first embodiment, the controlling unit 2 obtains type information of a recording medium used for a recording process upon receipt of the recording instruction information, and obtains information of an associated gap distance by referencing a table of FIG. 5 based on the obtained type information. The controlling unit 2 adjusts a gap distance to a distance indicated by the obtained information of the gap distance.

In steps S2 and S3, the controlling unit 2 counts the number of ink droplets jetted for each recording process, and accumulates the numbers of ink droplets jetted in all recording processes instructed by one piece of recording instruction information in a similar manner as in the first embodiment. However, the second embodiment is different from the first embodiment in a point that the number of jetted ink droplets is counted for each ink color.

Normally, if a type such as a color or the like of ink differs, its contained composition differs. Therefore, also natures such as viscosity and the like differ. Due to a nature difference, inks of different types have different occurrence rates of ink mist.

In the second embodiment, a difference of the occurrence rate of ink mist due to a difference of an ink nature is taken into account in addition to a difference of the occurrence rate of ink mist due to a difference of the flying distance of ink, which is taken into account in the first embodiment. Therefore, the number of jetted ink droplets is counted for each ink type. The second embodiment refers to an example of using four ink types such as C, M, Y and K that are different colors as ink types.

After the number of jetted ink droplets is counted for each of the ink colors C, M, Y and K in steps S2 and S3, the flow goes to step S4. In step S4, the number of jetted ink droplets, which is counted for each of the ink colors, is multiplied by correction information prepared for each of the respective ink colors illustrated in FIG. 5. In FIG. 5, an association is made between the type information and the gap distance in a similar manner as in FIG. 4. However, the correction information is individually set in association with each ink type, and a difference of the occurrence amount of ink mist, which is caused by a nature difference of ink, is represented as a relative ratio in FIG. 5.

In step S4, the controlling unit 2 corrects the occurrence amount of ink mist by multiplying the number of ink droplets jetted for each of the ink colors by the correction information associated with both the information of the gap distance obtained based on the type information and the type of jetted ink in FIG.5. The controlling unit 2 calculates the occurrence amount of ink mist generated in a recording process instructed by one piece of the recording instruction information, by adding up the obtained corrected numbers of jetted ink droplets for the respective ink colors.

In step S5, the controlling unit 2 reads the accumulated occurrence amount of ink mist, which is recorded in the storing unit 8, that is accumulated after the preceding cleaning. Then, the controlling unit 2 updates the accumulated occurrence amount of ink mist by adding the occurrence amount of ink mist, which is obtained in step S4, to the read accumulated occurrence amount of ink mist, and stores the updated amount in the storing unit 8. Processes in and after step S6 are executed in a similar manner as in the first embodiment.

In the second embodiment, an association is made between the flying distance of ink and correction information for each ink type. Therefore, also a nature difference of ink is taken into account in the determination of whether or not to clean the inside of the apparatus. Accordingly, even if a recording process is continuously executed mostly with a particular color ink, an estimation error of the occurrence amount of ink, which is caused by a nature difference of ink, is suppressed.

In the second embodiment, the table of FIG. 5 is configured by taking into account both an influence exerted by a change of the flying distance and an influence exerted by a difference of an ink type on the occurrence amount of ink mist. However, the table of FIG. 5 may be configured by taking into account only a change of the occurrence rate of ink mist, which is caused by an ink type.

Additionally, the occurrence rate of ink mist can possibly change due to various factors except for the above described flying distance and the type of ink.

For example, if an image is recorded in a state where a temperature, a humidity or the like changes, also the state (viscosity or the like) of ink varies with a change of the temperature or the humidity. Therefore, also the occurrence amount of ink mist varies. In such a case, by preparing a table that makes an association between a temperature or a humidity and correction information for reflecting a change of the occurrence rate of ink mist, which is caused by a temperature change or a humidity change, on the estimation of the occurrence amount of ink mist, the occurrence amount of ink mist can be estimated more accurately even if the temperature or the humidity change.

Alternatively, a burden imposed on the recording head differs depending on whether a recording process is executed with either a high frequency or a low frequency, and the occurrence rate of ink mist is changed by the burden. In such a case, by preparing, for example, a table that makes an association between a use frequency per week and correction information for reflecting a change of the occurrence rate of ink mist, which is caused by a difference of the use frequency, on the estimation of the occurrence amount of ink mist, also a change of the occurrence amount of ink mist, which is caused by a difference of the use frequency, can be addressed.

By using some embodiments according to the present invention in this way, the occurrence rate of ink mist, which is changed by other factors except for the above described ones, can be corrected, and the degree of contamination of the inside of the apparatus can be more suitably estimated.

Corrections made to due to various factors that change the occurrence rate of ink mist can be suitably combined and executed (for example, a correction made due to a flying distance and a correction made due to a temperature are combined). Moreover, if the corrections made due to various factors that change the occurrence rate of ink mist are combined, correction information may be respectively set under individual recording conditions, for example, as illustrated in FIG. 5. Alternatively, correction information used to correct the occurrence amount of ink mist may be generated by preparing a table that stipulates a value of correction information for each factor and by multiplying a plurality of pieces of correction information of factors that need a correction at the time of a recording process. For example, if a value of correction information due to a flying distance is 1.2 and a value of correction information due to a temperature is 1.4 under a certain recording condition, 1.68 obtained by multiplying 1.2 by 1.4 may be used as a value that corrects a change of the occurrence amount (occurrence rate) of ink mist, which is caused by both the flying distance and the temperature.

The above described first and second embodiments refer to the examples of using the gap distance adjusted by the lifting/lowering unit 6 as information of the flying distance of ink. However, the information of the flying distance of ink is not limited to this one. For example, a distance, measured with a laser distance meter or the like, between the conveyance member 5a and the image recording unit 3 may be used as the information of the flying distance of ink.

Additionally, the above described embodiments refer to the examples of using the number of ink droplets jetted from the recording head as information of the jetting amount of ink. However, the information of the jetting amount of ink is not limited to this one. For example, the jetting amount of ink used for a recording process may be obtained based on a change of the weight of an ink cartridge by monitoring the weight of the ink cartridge that supplies ink to the recording head.

If the image recording apparatus 1 has a function of changing the jetting amount of ink jetted from the recording head per dot, for example, in order to increase gray levels in a further embodiment, some embodiments according to the present invention can be effectively applied also to the image recording apparatus 1 that changes the jetting amount in this way not by simply counting the number of jetted ink droplets but by counting the number of ink droplets after respectively multiplying droplets by a ratio of jetting amounts at the gray levels as the counting of the jetting amount in step S2 of FIG. 3.

As described above, according to some embodiments of the present invention, a contamination of the inside of the apparatus, which is caused by ink mist, can be more accurately estimated depending on a recording condition for executing a recording process.

The above described embodiments refer to, as the examples, the cases where the image recording apparatus 1 is a printer device. However, the image recording apparatus 1 according to the present invention is not limited to the printer device. The image recording apparatus 1 may be a so-called complex machine including a copier, a scanner and the like.

The present invention is not limited to the above described embodiments, and should be construed as being inclusive of all modifications, equivalents and substitutions within the spirit and scope of the present invention, which are defined by the appended claims. For example, it is to be understood that various embodiments according to the present invention can be embodied by modifying components within a scope that does not depart from the spirit and scope of the present invention. It is also to be understood that various embodiments according to the present invention can be implemented by suitably combining the plurality of components disclosed in the above described embodiments. Alternatively, it is to be understood by those skilled in the art that the present invention can be implemented by deleting some from all the components disclosed in some embodiments.

What is claimed is:

1. An image recording apparatus for recording an image on a recording medium by jetting ink, comprising:
a jetting amount information obtaining unit configured to obtain information of a jetting amount of the ink;
a flying distance information obtaining unit configured to obtain information of a flying distance of the ink when being jetted;
an ink mist occurrence amount estimating unit configured to estimate an occurrence amount of ink mist, which is caused inside the image recording apparatus by jetting the ink, based on the information of the jetting amount and the information of the flying distance; and
a determining unit configured to determine whether or not to clean an inside of the image recording apparatus based on the occurrence amount of ink mist, which is estimated by the ink mist occurrence amount estimating unit.

2. The image recording apparatus according to claim 1, further comprising
a storing unit configured to store a table that indicates an association between the information of the flying distance of the ink and correction information for correcting the information of the jetting amount according to a change of an occurrence rate of the ink mist, which is caused by a change of the flying distance of the ink, wherein
the ink mist occurrence amount estimating unit obtains, from the table, the correction information associated with the information of the flying distance, which is obtained by the flying distance information obtaining unit, and estimates the occurrence amount of ink mist based on the correction information and the information of the jetting amount.

3. The image recording apparatus according to claim 1, further comprising:
a recording head configured to jet ink onto the recording medium; and
a conveying unit configured to convey the recording medium to a position to which the ink jetted by the recording head reaches, wherein
the information of the flying distance is information of a gap distance between the recording head and the conveying unit.

4. The image recording apparatus according to claim 3, further comprising:
a type information obtaining unit configured to obtain information about a type of the recording medium; and
a gap distance adjusting unit configured to adjust the gap distance according to the information about the type of the recording medium, which is obtained by the type information obtaining unit, wherein
the flying distance information obtaining unit obtains the information of the gap distance adjusted according to the information about the type of the recording medium as the information of the flying distance.

5. The image recording apparatus according to claim 3, wherein
the information of the jetting amount, which is obtained by the jetting amount information obtaining unit, is the number of ink droplets jetted onto the recording medium by the recording head.

6. The image recording apparatus according to claim 1, further comprising
an accumulating unit configured to calculate an accumulated occurrence amount of ink mist by accumulating the occurrence amount of ink mist, which is estimated by the ink mist occurrence amount estimating unit, after preceding cleaning, wherein
the determining unit determines to clean the inside of the image recording apparatus if the accumulated occurrence amount of ink mist is larger than a predetermined threshold value.

7. The image recording apparatus according to claim 4, wherein
the image recording apparatus records the image on the recording medium based on recording instruction information received from a higher-level device connected to the image recording apparatus, and
the type information obtaining unit obtains the information about the type of the recording medium from the recording instruction information.

8. The image recording apparatus according to claim 4, further comprising
a plurality of recording medium feeding units respectively configured to feed a different type of a recording medium to the conveying unit, wherein
the type information obtaining unit identifies a recording medium feeding unit that has fed the recording medium among the plurality of recording medium feeding units, and obtains the information about the type of the recording medium, which is associated with the identified recording medium feeding unit.

9. The image recording apparatus according to claim 1, further comprising
a notifying unit configured to output a specific notification if the determining unit determines to clean the inside of the image recording apparatus.

10. A method of controlling an image recording apparatus for recording a recording medium by jetting ink, comprising:
obtaining information of a jetting amount of the ink;
obtaining information of a flying distance of the ink in the jetting the ink;
estimating an occurrence amount of ink mist, which is caused inside the image recording apparatus by the jetting the ink, based on the information of the jetting amount and the information of the flying distance; and
determining whether or not to clean an inside of the image recording apparatus based on the occurrence amount of ink mist, which is estimated by the estimating.
